(19) United States
(12) Patent Application Publication
(10) Pub. No.: US 2024/0057821 A1
(43) Pub. Date: Feb. 22, 2024

(54) TWO-LEVEL FOOD SYSTEM FOR THE STEP-BY-STEP PREPARATION OF RESTAURANT-STYLE DISHES

(71) Applicant: Igor Sergeevich LERNER, Yaroslavl (RU)

(72) Inventor: Igor Sergeevich LERNER, Yaroslavl (RU)

(21) Appl. No.: 18/269,984

(22) PCT Filed: Dec. 3, 2021
(86) PCT No.: PCT/RU2021/000541

§ 371 Date: Jun. 28, 2023

(30) Foreign Application Priority Data
Dec. 28, 2020 (RU) 2020143385

(51) Int. Cl. A47J 44/00

(52) U.S. Cl. CPC A47J 44/00

(57) ABSTRACT

The claimed invention relates to the field of automatic high-tech professional food equipment for producing moulded, fast-cooked food items. An automatic dual system for producing food items comprises a pair of independent cold-cycle preparation subsystems and, connected thereto, a hot-cycle preparation subsystem. The cold-cycle subsystems are divided into a part for the preparation and temporary storage of food bases, a food distribution part, and a conveyor part. The hot-cycle preparation subsystem is divided into an in-motion heat treatment part, and a part for the temporary storage and release of the finished product. The overall operation of the equipment is controlled by a computer system having program control over means for transferring a finished or a partially finished product, said means being disposed within the limits of the initial sections of the conveyor parts. The result is increased productivity.

### FIELD OF THE INVENTION

The invention relates to the field of automatic high-tech professional food equipment which implies the implementation of autonomous, computer-controlled cyclic production operations providing high-quality and fast cooking of ready-to-eat restaurant-style dishes in autonomous mode.

### BACKGROUND OF THE INVENTION

SU 406326 (IPC A21C 5/00, published on Nov. 5, 1973; hereinafter—[1]) discloses a system for preparing baked food products.

This system belongs to equipment for the food industry, namely to units for the preparation of pizza-type dough products.

According to [1], the system for preparing the baked food products from pizza-type dough comprises a means for storing dough pieces, a device for feeding (sampling) the dough pieces and a conveyor device for receiving and transferring the dough pieces, which is powered by an electric motor. Furthermore, containers for supplying food additives are installed above the conveyor device, and after them, in the process of moving its movable body, an oven is equipped for baking incoming culinary dough products.

In the system disclosed in [1], the means for storing the dough pieces is implemented as a container for a single dough mass, and the device for feeding (sampling) the dough is installed on a suspension bracket and is designed for sampling the portions of dough and uniformly applying them on rotary working areas of a certain size and shape. In this case, the subsequent molding of the dough pieces to a preferably flat shape is carried out by means of a special device configured as a lever with a disk driven by a flywheel.

Except for the conveyor device with a movable working body powered by the electric motor, the rest of the devices and subsystems of the known system operate in a mechanical mode (i.e., the container for storing dough, the device for feeding the dough pieces, a dough molding device, etc.), and, accordingly, require the constant involvement of several operators-technologists during operation, which primarily affects the quality of production work, since the combination of manual labor of a person and the system served by him/her with the necessity to work at a fast pace is certainly associated with the manifestation of errors and inaccuracies in work, and secondly affects the speed of work and, accordingly on production volumes, since it is impossible to ensure a continuous cycle of operation of the system, since it is necessary to change personnel, replenish the containers with dough and food additives, as well as it is necessary to periodically repair and maintain the mechanisms used in the system. All of this generally characterizes the system as a system with an incomplete low-tech automation cycle and, accordingly, low technical and operational capabilities.

The additional and significant disadvantage of the system known from [1] should be considered the unforeseen possibility for organizing temporary storage of finished baked products, including in a heated state, as well as the impossibility of orderly and systematically distributing the products ready for delivery, which limits the functionality of the system and hinders the efficient and rational sale of products.

WO 19224799 (IPC A21C 15/04, published on Nov. 28, 2019; hereinafter—[2]) discloses an automated system for making pizza.

The system known from [2] generally relates to food production equipment, and specifically to an automatic pizza making device which includes robotic subsystems and automatic metering devices for making customized pizzas.

The automated system known from [2] is designed for preparing and packing pizza and comprises a subsystem for transferring dough pieces, a dough-piece preparation subsystem that includes food distribution modules, a heat treatment unit, product transferring mechanisms, a subsystem for storing and issuing finished products. There is also a control unit connected to all nodes and subsystems.

It should be noted that the above-mentioned subsystem for transferring the dough pieces is an electric conveyor which, due to the specifics of this unit, is programmed for movement with alternating stops and starts, which subsequently, during intensive use, can lead to inaccuracies in the positioning of a belt, thereby leading to failures in its operation and the necessity of technical intervention to eliminate the failures. Furthermore, the use of the conveyor in any systems requires increased energy resources and is inevitably associated with scheduled maintenance activities. In this regard, it can be assumed that the maintenance of this system is difficult, and its productivity is low.

Additionally, it can be noted that the system known from [2] lacks the technical capability of automated and continuous production control. Thus, there are certain risks of obtaining low-quality, and possibly hazardous to health, products that come directly to a consumer.

US 2020154949 (IPC A23L 19/00, published in 2020; hereinafter—[3]) discloses an automatic system for preparing fast food, which is closest in technical essence to the proposed invention.

According to [3], the system for obtaining fast food products is built on a modular basis and is autonomous in operation.

According to [3], the system for automated packaging of food products can comprise two production lines, the configuration of which allows them to be fully used independently of each other. The system further comprises a set of metering modules for temporarily storing and distributing food ingredients. The operation of equipment, including conveyor equipment with movable working elements, as well as the course of executing orders are controlled by a computer control system connected to a central serving server.

The technical peculiarity of the food system known from [3] is that one of the line configurations is intended for use on a freight vehicle, and another of the line configurations is intended for use in a permanently installed unit structurally and functionally similar to a grocery kiosk.

It should also be noted that this system uses an autonomous power source that is configured to maintain the operability of the equipment for a long time, which, as already mentioned, can be part of a freight vehicle, or can be part of a stationary kiosk.

The advantages of the system known from [3] can be considered its versatility and practicality in application, which are achieved due to the possibility of prompt movement of production equipment and its deployment in places unsuitable for food trade, as well as the possibility of adapting the production lines to various operational modes, implying traditional (conventional) operation in the format of stationary trading kiosks and original (specific) operation in the form of a trading culinary system that can quickly move from one trading platform to another.

As a disadvantage, it is advisable to note that as conveyor systems for the automatic variable-configuration production line, belt conveyor devices are used, the design features of which do not provide the proper indicators of smooth travel necessary for high-quality food production. Moreover, in the operating conditions of the equipment installed on a wheeled chassis, said disadvantage can be exacerbated, since there are additional factors that have a negative operational impact, such as the instability of the vehicle body position, the vibration of the vehicle engine, inertial loads, limited space, etc.

Structurally, the proposed automatic food system is designed such that both proposed configurations of the production lines need some addition, expressed in the form of an external case design that protects the internal equipment from the harmful effects of environmental factors and gives an object a finished appearance, giving presentability. Thus, the additional disadvantage of this system is a partially open and outwardly unattractive structural design that does not guarantee compliance with sanitary and hygienic standards.

### SUMMARY OF THE INVENTION

The technical problem to be solved by the invention lies in the creation of a universal composite two-level system for the preparation of molded culinary products with high technical and operational performance.

The technical result of the invention consists in the realization of the purpose of creating an original robotic system that has two functionally independent configuration working levels and has high efficiency, positional accuracy and processing (cooking) speed of incoming product orders.

The technical result is achieved and the technical problem is solved by the fact that an automatic dual system for producing ready-to-eat food products comprises a pair of independent cold-cycle production subsystems and a hot-cycle production subsystem connected thereto. The cold-cycle production subsystems are divided into a part for preparing and temporarily storing food bases, a food distribution part, and a conveyor part. The hot-cycle production subsystem is divided into an in-motion heat treatment part and a part for temporarily storing and issuing finished products. The part for preparing and temporarily storing the food bases is preferably (mainly) configured as a preparation cooling chamber selectively distributing and supplying the food bases, preferably frozen food bases, to the conveyor part configured as a two-coordinate carrier table moving along supporting structures under the working area of the food distribution part configured as an installed set of food modules distributing portions of food components to the food bases. The heat treatment part is preferably configured as a conveyor tunnel oven that feeds the received and subsequently baked products into the part for temporarily storing and issuing the finished products, which is configured as a segmented module issuing the finished products as they are identified. The overall operation of the equipment is controlled by a computer system connected to a central server and configured to perform software-based control over means for transferring the finished or partially finished products. Said means are arranged within the limits of initial sections of the conveyor parts to transfer the finished non-bakeable products directly to the part for temporarily storing and issuing the finished products, as well as within the limits of end sections of the conveyor parts to transfer the partially finished products to be baked to the heat treatment part.

According to the most expedient and preferred embodiment of the invention, a metering device for pouring dough for pancakes is equipped within the inlet section of the conveyor tunnel oven.

According to one of the rational embodiments of the invention, the two-coordinate carrier table comprises a base on which an independently movable platform is installed. The platform has a lower part that moves in a longitudinal direction and an upper part that moves in a transverse direction. In one embodiment, the platform may potentially perform an axial rotation by 360°, which provides the ability to move the two-coordinate carrier table in different directions on the plane.

According to one of the best embodiments of the invention, the two-coordinate carrier table is equipped with a digital product quality monitoring tool which is configured as a photo and/or video camera.

According to one of the most rational embodiments of the invention, weight sensors may be installed under the platforms of the two-coordinate carrier tables as an additional product quality monitoring tool, the signal from which is sent to an intelligent control device after each operation performed on the food base to determine its compliance by weight to reference products.

According to one of the possible embodiments of the invention, the supporting structures are configured as two statically installed guides.

The computer system of the invention is configured to analyze incoming images from the product quality monitoring tool and, in case of incomplete reference compliance of the products, generate programmed command signals activating the necessary operational modes of the equipment aimed at eliminating deficiencies of the products.

According to the inventive concept, the food bases are made of dough or other flour bases, are preferably flat and have a round and/or oval and/or rectangular and/or square configuration.

In addition, the part for temporarily storing the food bases may be equipped with a compartment for storing non-frozen bakery food bases of various shapes and configurations and a cooling chamber for storing molded food bases.

The set of food modules used in the invention may be installed sequentially in a row and, as a rule, comprises loose, pasty, solid, semi-solid and liquid food additives.

Also, in order to optimize space, the set of food modules of the food distribution part may be installed in pairs in a row, since the independently movable working platform of the two-coordinate carrier tables is installed on the base, with its lower part being configured to move in the longitudinal direction and its upper part being configured to move in the transverse direction.

The food modules, in a particular embodiment of the invention, comprise meat and/or minced meat and/or sausage products and/or ham and/or fish and/or cheese and/or vegetables and/or fruits and/or berries and/or herbs and/or sauce and/or spices and/or oil and/or syrup and/or cereals and/or dough.

In accordance with the inventive concept, attention is drawn to the design of a dual system for producing molded culinary products, preferably made of a flour base, in automatic mode.

The design of this dual system provides high-quality and fast automatic cooking of ready-to-eat dishes in autonomous mode, including, but not limited to: hamburgers, sandwiches, buttered breads, shawarma, burritos, pizza, fajitas, French fries, fried potatoes, hot dogs, pancakes with filling, soups, salads, dumplings, manti, fried and baked meat, cutlets, thermally processed vegetables, thermally processed cereals, Belgian waffles, pastries, pies, cakes.

The dual system is characterized by the presence of two independent production levels (lines) that carry out “cold” culinary treatment of incoming food bases in the format of sequential batch application of various food ingredients in accordance with a specific recipe for a pre-selected food dish. These production levels provide paired operation of the system and may operate both sequentially and synchronously, as well as in parallel, preparing different dishes at the same time depending on the tasks assigned. All of this allows one to work in different modes, on multiple orders, while providing an impressive range of products having a wide variety of food filling and maintaining a stable production potential.

As “hot” treatment, an oven installation having a fixed inner chamber or an oven installation having a movable belt is used. The movable belt moves the products for pre-treatment before packaging, and then the products enter a subsystem for temporary storage and automatic issuance to a specific customer. In technical terms, all of this comprehensively complements this food system and characterizes it as an autonomous automatic full-cycle fast-food production system which is configured to cook according to an individual predefined recipe, thereby implying the ability to adjust the parameters and operational modes of the equipment that have a direct impact on the molding and taste characteristics of the resulting food products.

The essential feature of the invention consists in the technical possibility of manufacturing food products subjected to heat treatment and not subjected to heat treatment. This is achieved by using unique conveyor devices configured as the two-coordinate carrier tables on “cold” production lines (levels), which, moving along supporting guides, if necessary, may transfer the food bases directly to the “hot” production line, or may return back to the beginning of their journey and transfer substantially finished products immediately to the part for temporarily storing and issuing the finished products, said part being made, according to the inventive concept, in the form of the segmented module issuing the finished products as they are identified.

The key factor in the operation of the proposed automatic two-level dual system is the presence of the computer control system that is connected to the central serving server and comprises the appropriate software and hardware functionality necessary for the smooth and automatic operation of all equipment that can operate according to numerous built-in algorithms and algorithms directly defined by a customer through the existing software application of the system. These algorithms allow a customer to program the system individually and uniquely at his/her discretion to obtain original food products of proper quality, which is also provided by the system automation.

Also, the food distribution part configured as the set of food modules has a significant impact on the operation of the culinary system, which, in combination with the operation of the conveyor system in the form of the stable two-coordinate carrier table, ensures high positional and metering accuracy of applying food ingredients, since the movement of the two-coordinate carrier table is smooth, vibrations are minimized, and there is also the possibility of lateral movement and axial 360-degree rotation of the independent platform of the carrier table relative to the set of food modules.

Thus, the above-proposed constructive implementation of the automatic dual system for manufacturing ready-to-eat food products, taking into account its characteristics and technical features, forms a set of features sufficient to achieve the desired technical result, which consists in realizing the purpose of creating an original robotic system having two functionally independent configuration working levels and having high efficiency, positional accuracy and speed of processing (cooking) of incoming product orders, as well as to solve the existing technical problem of creating a universal composite two-level system for preparing molded culinary products with high technical and operational performance.

### BRIEF DESCRIPTION OF THE DRAWINGS

FIG. 1 shows a block diagram of the proposed dual automatic system.

FIG. 2 shows a side view of a two-coordinate carrier table.

FIG. 3 schematically shows one embodiment with the original implementation of food modules for topping food bases placed on cold line conveyors with ingredients.

### DETAILED DESCRIPTION OF THE INVENTION

The invention is explained by a specific exemplary embodiment which, however, is not the only possible, but clearly demonstrates that the specified set of essential features allows one to achieve the desired technical result, as well as to solve the existing technical problem.

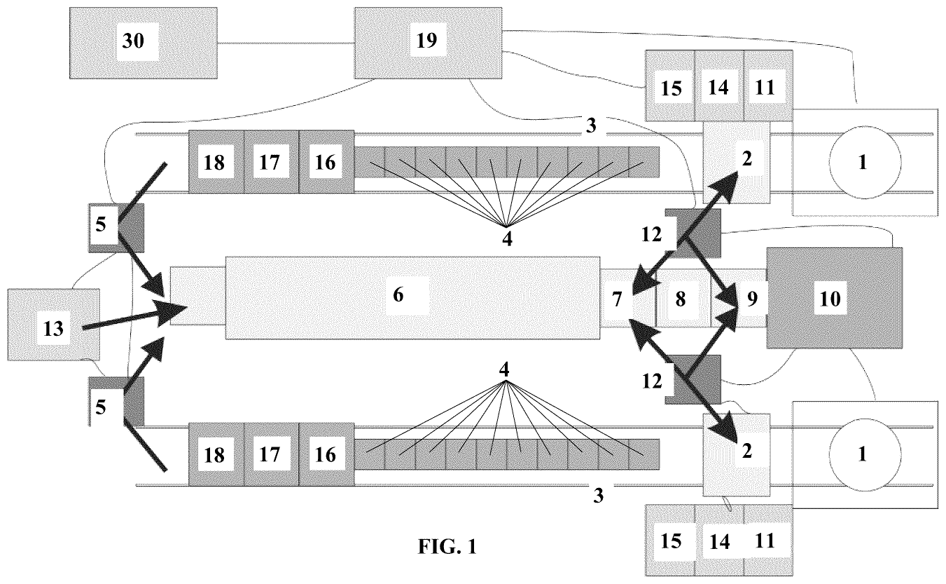

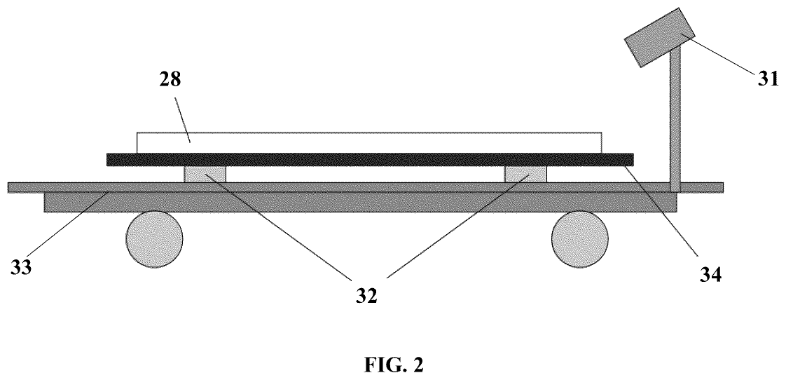

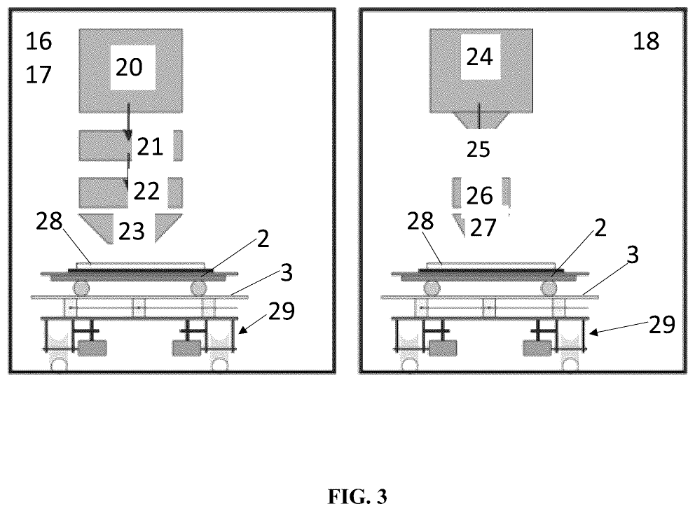

FIGS. 1-3 show the following parts and elements of the proposed automatic dual system for manufacturing ready-to-eat food products:
1—preparation cooling chamber with a device for feeding food bases;
2—two-coordinate carrier table;
3—supporting structures in the form of guides;
4—food modules;
5—means for transferring partially finished products;
6—conveyor tunnel oven;
7—outlet section of the conveyor tunnel oven;
8—means for cutting food products;
9—packaging subsystem;
10—module for issuing finished products;
11—second cooling chamber for bread and confectionery bases;
12—means for transferring finished products;
13—metering device for pouring dough for pancakes;
14—compartment for storing non-frozen bakery bases;
15—third cooling chamber for storing molded culinary bases;
16—special food module for storing and supplying chicken meat ingredients;
17—special food module for storing meat beef ingredients;
18—special food module for storing ingredients in the form of minced meat;
19—computer system;
20—unit for storing meat ingredients;
21—unit for frying meat ingredients;
22—unit for grinding meat ingredients;
23—metering device for meat ingredients;
24—unit for storing minced meat;
25—unit for molding cutlets;
26—unit for frying cutlets;
27—metering device for flat cutlets;
28—food bases;
29—electrically driven connection of a two-coordinate carrier table;
30—central server;
31—product quality monitoring tool;
32—scales;
33—platform;
34—metal base.

Thus, the proposed automatic dual system for manufacturing ready-to-eat food products comprises two separate and independent cold-cycle production subsystems and a hot-cycle production subsystem connected thereto.

Each of the cold-cycle production subsystems has its own part for preparing and temporarily storing food preparations 28, as a rule, frozen, its own food distribution part and its own conveyor part.

Each of these parts for preparing and temporarily storing the food blanks comprises a preparation cooling chamber 1 with a device for feeding the food blanks to a conveyor device. In addition, these parts also include a second cooling chamber 11 for bread and confectionery blanks, a compartment 14 for storing non-frozen bakery bases, and a third cooling chamber 15 for storing molded culinary bases.

Both the first and second food distribution parts comprise food metering modules 4, as well as special food metering modules 16, 17 and 18, which are designed for metered distribution of food components to the food bases 28.

The food metering modules 4, as a rule, are implemented as controlled bunker-type batchers.

Each of the special food metering modules 16 and 17 includes a unit 20 for storing meat ingredients, a unit 21 for frying the meat ingredients, a unit 22 for grinding the meat ingredients and a metering device 23 for the meat ingredients, which are all interconnected and sequentially installed one above the other.

The unit 20 for storing the meat ingredients is configured as a device comprising a hollow body with an inlet for the contents and an electric screw-conveyor mechanism located inside the body and treating the contents with the release of the latter to the outside.

The unit 21 for frying the meat ingredients is configured as a fenced platform with a frying surface, on which meat contents fall. The frying surface rotates around an axis and is divided into sections by working blades that mix the contents, which are subsequently released to the outside by means of an adjustable valve.

The unit 22 for grinding the meat ingredients is configured as a fenced platform with a working surface, on which the contents are crushed under the action of rotary knife elements installed radially, whereafter the ingredients come out.

The metering device 23 for the meat ingredients is configured as a controlled bunker-type batcher.

The special food module 18 for storing minced meat ingredients comprises a unit 24 for storing minced meat, a unit 25 for molding cutlets, a unit 25 for frying the cutlets and a metering device 27 for flat cutlets, which are all interconnected and arranged one above the other.

The unit 24 for storing the minced meat is configured as a device comprising a hollow body with an inlet for the contents and an electric screw-conveyor mechanism located inside the body and treating the contents to produce the minced meat at the outlet.

The unit 25 for molding the cutlets is configured as a molding device, the working components of which are configured to cover the minced meat, divide it into portions and give the treated mass a disk-like shape.

The unit 26 for frying the cutlets is configured as a fenced platform with a frying surface, on which the cutlets fall. The frying surface is divided into sections by working blades that turn the cutlets and, once they are ready, move the cutlets to an adjustable valve for their exit to the outside.

The metering device 27 for the cutlets, as a rule, is configured as a controlled weight batcher.

Both the first and second conveyor parts comprise a two-coordinate carrier table 2 which moves along supporting structures configured as guides 3 statically mounted on the supporting surface.

Said production hot-cycle subsystem is divided into a in-motion heat treatment part and a part for preparing, temporarily storing and issuing finished products.

The heat treatment part is configured as a conveyor tunnel oven 6, the movable belt element of which delivers the products received and baked in the oven 6 to the part for temporarily storing and issuing the finished products. The latter includes a module 10 for issuing the finished products, which is divided into compartments and issues the finished products as they are verified.

The module 10 for issuing the finished products typically includes a heating element to maintain the desired level of heat required for long-term storage of the finished products.

At the outlet of the conveyor tunnel oven 6, an outlet section 7 is installed, and a means 8 for cutting the food products and a packaging subsystem 9 are installed further in front of the issuing module 10.

The means 8 for cutting the food products is configured as a composite system comprising a base and a vertical press. The products are supplied to the base, and the vertical press contains a movable platform, the outer surface of which is a working surface and contains a replaceable insert designed for dividing the products into segments.

The packaging subsystem 9 is configured as a segmented module equipped with automatic manipulators which, according to an established programmed cycle, perform sequential packaging of incoming dishes based on an approved operation algorithm.

The overall operation of all equipment of the automatic dual system is controlled by a computer system 19 that is connected to a central serving server 30 and is configured to perform software-based control over a means 12 for transferring the finished products and a means 5 for transferring the partially finished products.

Moreover, the means 12 for transferring the finished products is located within the initial sections of the conveyor parts and, accordingly, transfers the finished products not to baked directly to the part for temporarily storing and issuing the finished products. The means 5 for transferring the partially finished products is located within the end sections of the conveyor parts and, accordingly, transfers the partially finished products to be baked to heat treatment part.

In the proposed food system, as a rule, these cold-cycle production subsystems are installed in parallel and opposite to each other, and the hot-cycle production subsystem is between them, although there may be any other arrangement that ensures the proper interaction of said subsystems.

Within the inlet section of the conveyor tunnel oven 6, a metering device 13 for pouring dough for pancakes is equipped, which is a tank of a given volume for storing dough (made of glass, stainless steel, other material). The tank is equipped with a dough supply valve and a device for distributing dough onto a food base (batcher) with a circular rotation function, which are controlled by an electric motor.

The two-coordinate carrier tables 2 used in the system comprise a base on which an independently movable platform 33 is installed, the lower part of which moves in the longitudinal direction and the upper part of which moves in the transverse direction. The platform 33 is also configured to rotate around the axis by 360°.

The two-coordinate carrier tables 2 are equipped with digital product quality monitoring tools 31 which are represented by photo/video cameras.

Under the platform 33 of the two-coordinate carrier tables 2, scales 32 are installed, which are necessary for the control weighing of manufactured products.

The food bases 28 typically contain dough or other flour base, are flat and have a round and oval configuration.

The proposed automatic dual system for preparing the ready-to-eat food products operates as follows.

It should be noted that the purpose of the following description of the invention is not to limit it to a specific embodiment, but rather to cover all possible additions that do not go beyond the scope of the appended claims.

The entire production process is controlled by the computer system 19 which is connected to the central serving server 30 connected to the Internet.

The computer system 19 and its associated central serving server 30 may use software that provides the transmission of information about incoming orders and about the operation of the equipment of the proposed dual culinary system.

It is possible to order a selected culinary product, for example, pizza, pancakes, hamburger, as well as select its filling and indicate the features of its preparation, through a software application on any electronic device or directly in the automatic dual system that provides such an opportunity.

The computer system 19 receives the corresponding signal, processes it, and then forms a certain operational mode of the equipment, in particular, determines a topping route of the conveyor part configured as the two-coordinate carrier table 2, namely, selects the desired cold-cycle production system for operation, selects the optimal speed of movement of the two-coordinate carrier table 2, fixes the time of its movement and stops, as well as determines other production parameters and determines the operational modes of the food distribution part, namely the special food metering modules 16, 17 and 18 with their possible synchronization relative to each other, checks the required dosage of the food metering modules 4, the presence of the necessary food ingredients in them, and determines other production parameters necessary for the preparation of specific food dishes with their own recipe.

The database of the central serving server 30 pre-stores all possible cooking programs for various culinary products, including the operational modes of the food distribution systems, the conveyor parts and, if necessary, the heat treatment parts.

In this embodiment of the invention, the food bases 28 made of frozen dough and the food bases 28 as freshly baked pieces are used for preparing cold sandwiches and various other dishes.

After the central serving server 30 receives information about the order of a certain product, the computer system 19 generates, through a software algorithm, a command for the preparation cooling chamber 1 to supply the food base 28 in the form of frozen round dough to the two-coordinate carrier table 2 of the first cold-cycle production subsystem. Almost simultaneously, a command is generated, which causes the compartment 14 for storing unfrozen bakery bases to supply the food base 28 in the form of a fresh bread bun to the two-coordinate carrier table 2 of the second cold-cycle production subsystem.

At the same time, said supply of the food bases 28 to the two-coordinate carrier tables 2 occurs through the original feeders, each of which is made as an actuator, such as an electric drive, equipped with a piston, a pusher, and a gripping means.

Further, according to the approved automatic operation algorithm, the food base 28 in the form of a frozen dough base moves on the two-coordinate carrier table 2 and is topped with the necessary type and amount of food ingredients according to the established recipe of the desired food product (pizza). For this purpose, the two-coordinate carrier table 2 makes necessary stops, production pauses, and moves, if necessary, the independent platform in the transverse direction for a uniform distribution or application of one or another food ingredient. After that, the same two-coordinate carrier table 2 drives up to the end section of the first cold-cycle production subsystem and transfers the partially finished pizza by means of the transferring means 5 to the conveyor tunnel oven 6. The executive movable element of the oven 6 moves the baked product, when it is ready, to the outlet section 7, whereafter the baked product goes to the working platform of the means 8 for cutting the food products. Further, if necessary, the product is packed in the packaging subsystem 9 and ultimately enters the module 10 for issuing the finished products, where the pizza takes its place in a corresponding cell and awaits its identification for release to a customer.

The means 5 for transferring the partially finished products is configured as an actuator having a piston-pusher with a gripping means that holds the food base and moves it from the platform of the two-coordinate carrier table 2 to the inlet section of the tunnel conveyor oven 6.

At this time, the food base 28 in the form of the fresh bread bun moves on the two-coordinate carrier table 2 of the second cold-cycle production subsystem and is topped with the necessary type and amount of food ingredients according to the established recipe for the desired food product (cold sandwich). For this purpose, the two-coordinate carrier table 2 makes necessary stops and production pauses, and moves, if necessary, the independent platform 33 in the transverse direction for a uniform distribution or application of one or another food ingredient to the surface. After that, this two-coordinate carrier table 2 returns back to its original position, and the almost finished product which does not require heat treatment is transferred through the transferring means 12 to the outlet section 7 or immediately to the packaging subsystem 9. Immediately after that, the cold sandwich is provided to the module 10 for issuing the finished products, where it takes a place in a corresponding cell of the cooled part of the issuing module and awaits its verification for release to the customer.

The means 12 for transferring the finished products is configured as an actuator having a piston-pusher with a gripping means that holds the food base and moves it from the platform of the two-coordinate carrier table 2 to the outlet section 7 of the conveyor tunnel oven 6 or immediately to the packaging subsystem 9.

The control system is also pre-provided with data-coordinates of the action area of each food module 4 and each special food module 16, 17 and 18 of each cold-cycle subsystem. As a result, by controlling the movement of both two-coordinate carrier tables 2, the computer system always delivers the food base 28 to a strictly defined place for applying a certain food ingredient.

By using the two independent production levels of the cold-cycle subsystems in the proposed system in combination with the conveyor means moving along them in the form of the two-coordinate carrier tables 2, it is possible to significantly increase productivity and the range of resulting products, since the system throughput is expanded, and the variability of production is characterized by the ability to simultaneously produce baked products and non-bakeable products. The technical problem of ensuring high speed, volume and quality of treatment (preparation) of food orders is also comprehensively solved, which in particular is manifested in improved molding of the resulting food products.

Thus, the completed orders (cooked pizza and cold sandwich) eventually go to the packaging stage in the packaging subsystem 9, from where they are driven by electric drives to the final stage of temporary storage and issuance in the module 10 for issuing the finished products.

The module 10 for issuing the finished products has equipment for temporarily storing and distributing the completed orders, which, as necessary, are fed into an issuing window according to a command coming from the computer system in accordance with the previously placed order.

After the order is completed, the computer system 19 sends a signal to the central serving server 30 which sends a notification to the customer on his/her mobile device or in another way, including notifying an operator that the order is ready and is to be transferred to a specific customer.

If the order was placed remotely via the Internet, the received notification contains a secret code that allows one to identify this customer, for which the customer approaches the issuing module 10, enters this code on a touch screen, or brings the mobile device to a system reader and shows a QR code received from the central serving server 30 of the system 30.

The program installed on the computer system 19 identifies this customer and activates a pick-up box into which the product has arrived, whereby the customer has an immediate opportunity to receive his/her selected order.

Each two-coordinate carrier table 2 may comprise a product quality monitoring tool 31 in the form of a photo/video camera.

During the movement of the two-coordinate carrier tables 2, the product quality monitoring tool 31 transmits information about the appearance of the products before and after the application of food ingredients to the computer system, and the absence of foreign objects on the food base 28 is also monitored.

If the software of the computer system 19 determines a low quality assessment and deficiencies of the food base 28, for example, the uneven application of the food ingredient, the computer system, having determined this fact, will be able to give a command to the two-coordinate carrier tables 2 and the food metering modules to actually change the state of the food base 28, i.e., create the necessary operational modes of the cold-cycle subsystem aimed at eliminating the product deficiencies.

If it is technically impossible to correct the food base 28, the computer system 19 signals the operator to stop work for quick maintenance.

In the presented embodiment, the main production equipment of the proposed dual food system is combined for visual inspection and is covered with a transparent protective display.

For safety reasons, the proposed automatic dual system may be limited on all sides by a housing fence containing an opening for maintenance.

In addition, this food system may be made in the form of a stationary vending machine, a system installed on a vehicle or containing wheels for movement, or the proposed system may be installed indoors as a stationary trade facility.

The invention may be widely used in the food service industry, as a safe and technological fast-food system.

What is claimed is:

1. An automatic dual system for manufacturing ready-to-eat food products, comprising:
a pair of independent cold-cycle production subsystems; and
a hot-cycle production subsystem connected to the cold-cycle production subsystems;
wherein the cold-cycle production subsystems are divided into a part for preparing and temporarily storing, preferably frozen, food bases, a food distribution part, and a conveyor part;
wherein the hot-cycle production subsystem is divided into an in-motion heat treatment part and a part for temporarily storing and issuing finished products;
wherein the part for preparing and temporarily storing the food bases is preferably configured as a preparation cooling chamber selectively distributing and supplying the food bases, preferably the frozen food bases, to the conveyor part configured as a two-coordinate carrier table configured to move along supporting structures under a working area of the food distribution part configured as an installed set of food modules configured to distribute portions of food components to the food bases;
wherein the heat treatment part is preferably configured as a conveyor tunnel oven configured to feed the received and subsequently baked products into the part for temporarily storing and issuing the finished products;
wherein the part for temporarily storing and issuing the finished products is configured as a segmented module issuing the finished products as the products are identified;
wherein the overall operation of the equipment is controlled by a computer system connected to a central server and further configured to perform software-based control over means for transferring the finished or partially finished products;
wherein said means are arranged within limits of initial sections of the conveyor parts to transfer the finished non-bakeable products directly to the part for temporarily storing and issuing the finished products, as well as within limits of end sections of the conveyor parts to transfer the partially finished products to be baked to the heat treatment part.

2. The system of claim 1, wherein a metering device for pouring dough for pancakes is equipped within an inlet section of the conveyor tunnel oven.

3. The system of claim 1, wherein the two-coordinate carrier table comprises a base on which an independently movable platform is installed, the platform having a lower part configured to move in a longitudinal direction and an upper part configured to move in a transverse direction.

4. The system of claim 1, wherein the two-coordinate carrier table is equipped with a digital product quality monitoring tool.

5. The system of claim 4, wherein the digital product quality monitoring tool is configured as a photo and/or or video camera.

6. The system of claim 1, wherein the supporting structures are configured as two statically installed guides.

7. The system of claim 4, wherein the computer system is configured to analyze incoming images from the product quality monitoring tool and, in case of incomplete reference compliance of the products, generate programmed command signals activating necessary operational modes of the equipment aimed at eliminating deficiencies of the products.

8. The system of claim 1, wherein the food bases are made of dough or other flour bases, are preferably flat and have a round or oval or rectangular or square configuration.

9. The system of claim 1, wherein the set of food modules is installed sequentially in a row and comprises loose, pasty, solid, semi-solid and liquid food additives.

10. The system of claim 9, wherein the food modules comprise meat and/or or minced meat or sausage products or ham or fish or cheese or vegetables or fruits or berries or herbs or sauce or spices or oil or syrup or cereals or dough.
